(19) United States
(12) Patent Application Publication
(10) Pub. No.: US 2004/0180125 A1
(43) Pub. Date: Sep. 16, 2004

(54) Cyclodextrin-containing compositions and methods

(76) Inventors: David W. Plank, Taylors Falls, MN (US); Daniel J. Lewandowski, Bloomington, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 10/658,682

(22) Filed: Sep. 9, 2003

Related U.S. Application Data
(63) Continuation-in-part of application No. 10/627,427, filed on Jul. 25, 2003.
(63) Continuation-in-part of application No. 10/386,244, filed on Mar. 11, 2003.
(63) Continuation-in-part of application No. 10/630,489, filed on Jul. 30, 2003.

(51) Int. Cl. A23L 1/22

(52) U.S. Cl. 426/534

(57) ABSTRACT

Flavor stability and/or textural stability of food products are surprisingly improved by incorporation of cyclodextrins in the food product. The cyclodextrins, preferably alpha cyclodextrins are incorporated in and/or on the food product. Preferably, the cyclodextrin is provided in a hydrated form in combination with a fat. Methods of making food products, compositions, methods of using compositions and methods of formulation are provided.

### CROSS-REFERENCES TO RELATED APPLICATIONS

This application is a Continuation-in-part of U.S. Ser. No. 10/627,427, filed Jul. 25, 2003, entitled, “METHOD OF REDUCING TRANS FAT LEVELS IN FOOD PRODUCTS AND FOOD INTERMEDIATES AND PRODUCTS AND INTERMEDIATES PRODUCED THEREBY.” This application is also a Continuation-in-part of U.S. Ser. No. 10/630,489, filed Jul. 30, 2003 entitled “TREATMENT COMPOSITION FOR REDUCING ACRYLAMIDE IN FOOD PRODUCTS AND FOOD INTERMEDIATES.” This application is also a Continuation-in-part of U.S. Ser. No. 10/386,244, filed Mar. 11, 2003, entitled “TREATMENT COMPOSITION FOR REDUCING ACRYLAMIDE IN FOOD PRODUCTS AND FOOD INTERMEDIATES AND PRODUCTS AND INTERMEDIATES PRODUCED THEREBY.” The disclosures of these priority documents are hereby expressly incorporated by reference.

### FIELD OF THE INVENTION

The invention relates to food compositions and compositions for treating food comprising cyclodextrin.

### BACKGROUND

Cyclodextrins have been used principally for the encapsulation of insoluble compounds on a molecular basis in order to enhance stability, reduce volatility and alter solubility as well as to increase shelf life of certain products. Such prior uses of cyclodextrins have been limited to flavor carriers and protection of sensitive substances against thermal decomposition, oxidation and degradation. In addition, more recently, cyclodextrins have also been used to remove fatty acids and cholesterol from animal fats and to remove cholesterol and cholesterol esters from egg yolks.

One potential solution to the high cholesterol problem teaches the treatment of the foodstuffs themselves with cyclodextrins rather than the consumer. U.S. Pat. Nos. 5,498,437, 5,342,633 and 5,063,077 discuss various processes for the removal of cholesterol and cholesterol esters from egg yolks, meat, animal fats, etc. It is thought that by reducing the level of cholesterol in such foodstuffs that overall levels of cholesterol may be reduced in consumers. However, processing steps to such foodstuffs increases the cost of delivering such products to market.

### SUMMARY OF THE INVENTION

In one aspect, the present invention surprisingly improves the flavor stability of a food product by incorporation of a cyclodextrin. For purposes of the present invention, a food product is considered to have flavor stability if the flavor characteristics of the food product remains essentially the same throughout the designated shelf life of the product. For example, test subjects when sampling a ready to eat (“R-T-E”) cereal noticed an improvement in the toasted flavor of the grains. It is believed that the alpha-cyclodextrin that was incorporated in the particular cereal evaluated, enhanced or accentuated the toasted grain flavor of the food product as opposed to carrying flavors that may not necessarily be inherent in the product, as may have been done with other cyclodextrins in the prior art.

In another aspect, the present invention surprisingly improves the textural stability of a food product by incorporation of a cyclodextrin. For purposes of the present invention, a food product is considered to have textural stability if the textural characteristics of the food product remains essentially the same throughout the designated shelf life of the product. Thus, food products that are designed to exhibit a crispy characteristic should remain crispy under ordinary storage conditions throughout the life of the product. Similarly, food products that are expected to be consumed when mixed with a fluid, such as milk, and yet remain crispy should do so throughout the designated shelf life of the product. Preferred examples of this are ready to eat breakfast cereal products. Products that are designed to be springy in texture, such as breads, cakes, doughnuts and the like, should retain that springy characteristic throughout the designated shelf life of the product.

In particular, the present invention provides crispy food products that maintain their crispiness over time and with exposure to humid conditions. Further, incorporation of cyclodextrin allows the preparation of crispy food products that contain more water in the food product, with higher degree of crispiness than would be expected at the beginning of the product life cycle. This enhanced crispiness provides substantial benefit is reducing production costs, because not as much water needs to be removed from the product, while still achieving the desired crispy organoleptic properties. Additionally, it has surprisingly been found that crispy products comprising cyclodextrin exhibit less breakage than like products that do not contain cyclodextrin.

Further, it surprisingly has been found that the present invention facilitates the formulation of food products having a higher water content than like products that do not comprise cyclodextrin without sacrifice of textural and/or flavor characteristics. Surprisingly, the higher water content products tend to not possess undesirable chemical byproducts after cooking, such as acrylamide.

The present invention provides a surprising stability and continued crispness of drier components of products comprising a plurality of components having different water content. Thus, crispness is maintained even when the difference between the water content of the components in the food product is greater than about 3% by weight, and more preferably greater than 5% by weight. As a specific example, a dry cereal may comprise a grain component and a dried fruit component. The grain component may have a water content of about 5% by weight. The dried fruit component may surprisingly have a water content of greater than 8%, and more preferably greater than 10% by weight, with the grain component exhibiting surprisingly superior organoleptic properties over time as compared to a like product not containing cyclodextrin as described herein.

The present invention particularly provides an advantage in that, by incorporation of cyclodextrin in a multi-component food product, and particularly in the drier component of the multi-component food product, one can incorporate components at a higher water content than was previously possible while maintaining the desired organoleptic properties of the overall product.

### BRIEF DESCRIPTION OF THE DRAWING

The accompanying drawings, which are incorporated in and constitute a part of this application, illustrate several aspects of the invention and together with a description of the embodiments serve to explain the principles of the invention. A brief description of the drawings is as follows:

FIG. 1 is a bar graph showing the effect of added cyclodextrin in breakage of a flake R-T-E cereal product.

FIG. 2 is a bar graph showing the effect of added cyclodextrin in bowl life of a flake R-T-E cereal product.

FIG. 3 is a bar graph showing the effect of added cyclodextrin in bowl life of a flake R-T-E cereal product.

FIG. 4 is a bar graph showing the effect of added cyclodextrin in bowl life of a flake R-T-E cereal product.

FIG. 5 is a graph showing the effect of added cyclodextrin in the hexanal emission profile of a flake R-T-E cereal product.

FIG. 6 is a graph showing the effect of added cyclodextrin in the sensory score over storage time of a flake R-T-E cereal product.

### DETAILED DESCRIPTION

Cyclodextrins comprise a doughnut shaped or cyclical structure composed of a number of alpha-D-glucose units (typically 6-8) having a hydrophilic exterior and a hydrophobic interior. Alpha-cyclodextrin is a particularly preferred cyclodextrin for use in the present invention. Alpha-cyclodextrin a cyclized ring of six alpha 1,4 linked glucose units.

Cyclodextrins are generally water soluble, although alpha-cyclodextrin is likely more water soluble than beta-cyclodextrin or gamma-cyclodextrin, and free flowing crystalline powders that are substantially if not completely odorless and white in color. Alpha-cyclodextrin has a cavity dimension of about 0.50×0.79 (nm). The solubility of alpha-cyclodextrin at 25° C. is 14 (gm/100 mL). Alpha-cyclodextrin is available from Wacker Specialties, Adrian, Mich. 49221 and sold under the trademark CAVAMAX® W6 Wacker-Chemie, Burghausen, Germany.

Other cyclodextrins may be used in the present invention, and particularly are preferably used in combination or synergistically with alpha-cyclodextrin, such as beta-cyclodextrin and gamma-cyclodextrin, in particular ratios dependent upon the requirements of the manufacturer. In an exemplary embodiment, alpha-cyclodextrin may be used individually or may be combined with between 0-50% by weight beta-cyclodextrin or gamma-cyclodextrin and more preferably between 0.1 to about 40% by weight. Beta-cyclodextrins and gamma-cyclodextrins are also available from Wacker Specialties, Adrian, Mich. 49221.

One method of preparing cyclodextrins includes enzymatic treatment. Enzymatic degradation or treatment of the starch to produce cyclodextrins useful in the present invention is done through the use of cyclodextrin glucosyltransferase (CGTase, EC 2.4.1.19) or other enzymes, which results in a cyclic ring of sugar. Preferably, cyclodextrins are produced by the action of cyclodextrin glucosyltransferase on hydrolyzed starch syrups at neutral pH (6.0-7.0) and moderate temperature (35-40° C.). Alternatively, cyclodextrins can be produced in planta by the expression of the gene encoding CGTase in the food plant of interest.

The cyclodextrins as used in the present invention preferably are added to the food product without prior incorporation of encapsulates within the cyclodextrins, such as flavorants, sweeteners and the like. Most preferably, the cyclodextrins are added to the food product with no additional ingredients that could be contained within the cyclical structure of the cyclodextrin other than fat, as discussed below.

In accordance with the present invention, cyclodextrin may be internally incorporated in the food product as part of the mixing step of the various ingredients of the food product. Preferably, cyclodextrin comprises from about 0.5% to about 12% by weight, and more preferably from about 3 to about 6%, of the food product when internally incorporated. Most preferably, the cyclodextrin is provided in a hydrated form in combination with a fat.

Alternatively, cyclodextrin may be topically applied to the food product. When the product is cooked (e.g. by baking, deep frying, microwave heating and the like), the cyclodextrin may be applied either before or after cooking, as desired. Preferably, cyclodextrin comprises from about 0.2 to about 4% by weight, and more preferably from about 0.5% to about 1.5%, of the food product when topically applied. It has surprisingly been found the topical coating compositions are effective in improving the flavor and/or texture stability throughout the food product, even if these compositions are applied only to the surface of the food product. Most preferably, the cyclodextrin is provided in a hydrated form in combination with a fat.

In a preferred aspect of the present invention, the cyclodextrin is provided both as an ingredient of the matrix of the food product and as a topically applied coating composition.

Preferably the cyclodextrin is prepared for incorporation in the food product by first hydrating the cyclodextrin with water and mixing the hydrated cyclodextrin with a fat to form a cyclodextrin/fat composition. This cyclodextrin/fat composition may be incorporated into the matrix of the food product by mixing together with the other ingredients of the matrix. For example, when the food product is a grain-based cereal product, the cyclodextrin/fat composition may be mixed with the flour, water and other ingredients used to formulate the cereal.

Preferably, the cyclodextrin/fat composition is prepared as a coating composition to be topically applied to the food product. The cyclodextrin/fat composition may be provided in a solid or semi-solid state, but preferably is provided in a liquid state for ease of topical application to the food product. The cyclodextrin/fat composition may be coated on the food product in any manner as will now be apparent to the skilled artisan, including brushing the composition on the food product, or preferably applied as a spray. Topical application of cyclodextrin/fat compositions are particularly surprisingly effective in improving the flavor and/or texture stability throughout the food product, even if these compositions are applied only to the surface of the food product.

In preparation of the cyclodextrin/fat composition, preferred fat components are selected from oils and shortenings. Preferred oils include, for example, soybean oil, corn oil, canola oil, olive oil, sunflower oil, peanut oil, palm oil, palm kernel oil, coconut oil and other vegetable or nut oils. Preferred shortenings include, for example, animal fats such as butter and hydrogenated vegetable oils such as margarine. Mixtures of different fats are also contemplated.

In a specific embodiment, cyclodextrin is provided in a form suitable for application by an intermediate (such as a food service professional) or final consumer of the food product, so that the cyclodextrin may be separately applied at appropriate times in the food preparation and storage cycle.

As noted above, many types of food product may benefit from the present invention. While much of the present discussion focuses on R-T-E cereals, other types of products, and particularly grain based products, particularly benefit from the present invention. For example, breads and bakery products in general particularly benefit from both the textural and flavor stability benefits as described herein. Vegetable products additionally benefit from the present invention. In particular, starchy vegetable products, such as potatoes, are benefited by incorporation of cyclodextrin.

In one aspect of the present invention food products comprising a combination of components having different water content particularly and surprisingly benefit from incorporation of cyclodextrins as described herein. Examples of such food products that, by virtue of their manufacturing process, generate regions within the food product having different moisture content. Such product include, for example, baked goods having a drier outside portion with a moist inner portion, such as bread having a drier crust and a moist crumb. Another type of food product that particularly benefits from the present invention are combination food products comprising different materials incorporated into one product, such an R-T-E cereal having a dehydrated fruit in combination with a grain-based dry component, such as flakes.

The present invention particularly provides advantage in the food products having a plurality of components, where the water content difference between two of the components is at least 1%, and more preferably at least about 3%. Surprisingly, the incorporation of cyclodextrin as described herein appears to slow the migration of water from the higher content component to the lower content component. As noted above, the incorporation of cyclodextrin in components that are intended to be crispy may allow the same crispy textural characteristic to be achieved with a higher water content. The incorporation of cyclodextrin in both components, because of the affect of slowing the migration of water between components, may allow more water to be incorporated in both components while achieving the same or improved organoleptic properties. The incorporation of more water in the final food product provides substantial benefit in cost savings by avoiding the cost of water removal from the product.

Particular examples of fruits, and especially dried fruits, that benefit from the present invention include strawberry, blueberry, peach, grapes (raisins), plums (prunes), apples, oranges and so forth.

In an exemplary embodiment, a light colored cooked cereal composition such as a cereal dough or cereal mass a cooked cereal dough can be prepared by blending various dry cereal ingredients together with water and cooking to gelatinize the starchy components and to develop a cooked flavor. A pre-blend of wet ingredients may be prepared and combined with a pre-blend of the dry ingredients. The cooked cereal material or mass can also be mechanically worked to form cooked cereal dough. The cooking and mechanical work can occur simultaneously or sequentially. The dry ingredients can also include various cooked cereal dough additives such as sugar(s), salt and mineral salts, and starches. In addition to water, various liquid ingredients such as malt syrups can be added. A cooked cereal mash is quite similar to cooked cereal dough except that larger sized particles such as whole grains or cut grains are cooked rather than cereal flour ingredients.

While the invention finds particular suitability for use in connection with the provision of R-T-E cereals fabricated from cooked cereal doughs, the skilled artisan will appreciate that the present cooked cereal doughs can find applicability for use in connection with other grain based food products such as grain and vegetable based snack products. For example, the cooked cereal doughs can be formed into suitably sized, shaped and partially dried pellets or intermediates. These intermediates are useful in forming finished products. Finished grain or vegetable based snack products are usually provided by the deep fat frying or other puffing of the pellets (e.g., hot air or microwave heating) of partially dried intermediate products fabricated from cooked cereal doughs.

An advantage of producing intermediates is that they can be produced in bulk in one location and thereafter fried in one or more finish operations to form the finished snack products. Not only are shipping costs reduced due to the reduced volume of the intermediates compared to the finished products but also breakage of the finished product is reduced.

The cereal dough cooking step can be practiced using a batch, atmospheric cooker and a low pressure extruder cooker especially those equipped with a conditioner pre-cooker, or a twin screw extruder. The cereal dough is cooked with steam and sufficient amounts of added water for times and at temperatures sufficient to gelatinize the cereal starch and to develop desired levels of cooked cereal flavor.

The present exemplary method, for purposes of illustration, comprises the step of forming the cooked cereal dough or mass into individual pieces of a predetermined, desirable shape and size and having a particular moisture content. Conventional techniques and equipment can be employed to practice this step and the skilled artisan will have no difficulty in selecting those suitable for use herein.

For example, the dough having a moisture content of about 25% to 30% is first partially dried to a partially dried dough having a moisture content of about 12% to 20%. The partially dried dough can then be fed to piece forming apparatus that form the partially dried dough into individually shaped and sized pieces.

The present cereal compositions can be fabricated into any of a variety of common R-T-E cereal or snack forms including, shreds, biscuits, flakes, rings, or any common R-T-E cereal or cereal based snack product form, shape or size.

The present cereal compositions can also be formulated and fabricated so as to provide puffed cereals of various shapes and sizes such as “biscuits”. Especially desirable for use herein are biscuits, especially toasted biscuits. Especially for flakes, the forming step can first involve a sub-step of shaping the dough into pellets and then a finish step of shaping the pellets into a final desired shape such as flakes.

The cooked cereal dough can be fed to a pellet former to form pellets. In the preparation of R-T-E cereals in flake form, for example, the pellets can be sized to have a pellet count of about 35 to 50 per 10 g and a moisture content of 16 to 20%. In the preparation of a flaked R-T-E cereal, the pellets can be partially dried to moisture contents of about 18 to 20%. The pellets can then be formed into “wet” flakes having a thickness of about 380 to 635 μm (0.015 to 0.025 inch), preferably while warm 76.6 to 87.8° C. (170 to 190° F.) to form desirably shaped and sized wet flakes.

The dough can also be sheeted to form sheets of dough (e.g., 25 to 800 microns in thickness) and the individual pieces formed by cutting the sheet into individual pieces or by stamping out shaped pieces from the dough sheet.

The cooked cereal dough may also be extruded through a die imparting a desired peripheral shape to form an extrudate cooked cereal dough rope. The dough rope can be cut to form individual shaped pieces. In another variation, the cooked cereal dough is formed into individual “0” shaped pieces or rings, biscuits, shreds, figurines, letters, spheres or flakes or other geometric shapes, nuggets, or even irregular shapes. Next, the shaped and sized individual pieces are dried to form finished cereal products. The skilled artisan will appreciate that the drying step depends importantly in part upon the desired end product. For example, for end products in the form of puffable intermediates or pellets for snack production, the drying step can be practiced to provide a “finish” moisture content of about 10 to 15%. However, when the desired end product is an R-T-E cereal, drying the pellets to these moisture contents may only be an intermediate or sub-step prior to, for example, flaking the dried pellets to form “wet” flakes. These “wet” flakes can then be subjected to a finish or final drying step wherein the pieces are dried to final dried moisture contents of 1 to 4% such as by toasting. In another variation, the dough can be extruded under conditions of temperature and pressure so as to puff and expand (the “direct expansion” technique) and sectioned or cut into individual pieces to form individual expansions puffed R-T-E cereal or snack pieces. The cooked cereal dough can be puffable such as by deep fat frying, microwave heating, gun puffing, jet zone heating, etc. to prepare snack products.

The drying step can also involve heating the pieces under conditions that not only dry the piece but also cause the piece to expand to form dried and puffed or flaked finished pieces. For example, pellets can be gun puffed to form dried puffed R-T-E cereal products. The wet flakes can be toasted to dry, expand and tenderize to form finished R-T-E cereal flakes.

The pieces or pellets may also be deep fat fried to form dried puffed fried finished cereal products. Such dried puffed fried finished cereal pieces are especially desirable as snack products. Such products can absorb about 5 to 35% of frying fat during the drying and puffing step.

The cyclodextrin composition may optionally be mixed into the food composition at any convenient mixing step described above, as will be apparent to the skilled artisan. Alternatively or additionally, the cyclodextrin composition may be topically applied either before or after cooking of the food product.

In a particularly preferred embodiment, an oil or shortening based topical coating containing alpha-cyclodextrin, beta-cyclodextrin, gamma-cyclodextrin or combinations and modified derivatives thereof optionally with salt and/or flavors, may applied to form finished dried snack products. In an exemplary embodiment of the present invention, a fat product, in this case a shortening, may be formulated. In this example, samples were prepared using about 5 to 20% of alpha-cyclodextrin by weight of the product.

Shortening

| Ingredient | Weight Percentage |
|---|---|
| Oil* | 70% |
| Water | 13% |
| Alpha-cyclodextrin | 10% |
| Emulsifier** | 7% |

*Oil may be composed of, but not limited to: soybean oil, high-oleic sunflower oil, high-linoleic soybean oil, palm oil, palm kernel oil or coconut oil.
**Emulsifier may be composed of but not limited to: fully hydrogenated soybean oil mono-, di-, or tri-glyceride; mono-, di-, or tri-stearate.

This example was prepared by first hydrating the cyclodextrin in the water. The cyclodextrin-water mixture was added slowly to the oil-emulsifier mixture with constant stirring. The complete mixture is allowed to continue to stir for an additional 10 to 30 minutes to allow complete thickening of the shortening product.

The topical coating is applied in sufficient amounts such that after drying, if necessary, to remove added moisture associated with the coating solution, the coating is present in a weight ratio of coating to cereal base of about 1:100 to about 50:100, preferably 10:100 to about 40:100 and for best results about 25:100 to about 35:100.

Typically, the coating solution will have a blend of cyclodextrin and water and will comprise about 4 to 20% moisture. When higher amounts of the coating solution, particularly for those solutions employing higher moisture levels, the slurry coated cereal pieces maybe subjected to a final drying step to remove the added moisture from the coating to provide finished dried products having a moisture content of about 1 to 5%.

The R-T-E cereal pieces, snack products or the like, so prepared can then be conventionally packaged for distribution and sale.

In a particularly preferred aspect of the present invention, it has been discovered that the amount of cyclodextrin may have a surprising impact on a textural stability characteristic of a food product. In accordance with the present invention, one may make a food product by first determining information indicative of the impact that an amount of cyclodextrin has upon a textural stability characteristic of a food product. One may then, using this information, formulate a food product recipe comprising cyclodextrin.

Similarly, it has been discovered that the amount of cyclodextrin may have a surprising impact on a flavor stability characteristic of a food product. In accordance with the present invention, one may make a food product by first determining information indicative of the impact that an amount of cyclodextrin has upon a flavor stability characteristic of a food product. One may then, using this information, formulate a food product recipe comprising cyclodextrin.

Product Evaluation

Flake Breakage

The amount that a flake product breaks when imparted with stress may be evaluated using any appropriate test methodology. Preferably, the flake breakage is evaluated using a test that measures the percent by weight of flakes which are broken when shaken on a sieve in a manner as follows:

Flakes are screened through a cereal shaker sieve. 100 grams of flakes retained on the cereal shaker sieve are transferred to a RoTap sieve (US ¼″). Five (#5) rubber stoppers are placed on the flakes and shaken with the RoTap hammer down for 3 minutes. The rubber stoppers bounce around, breaking the more fragile flakes. The amount of sample which is broken and falls through the ¼″ sieve is weighed.

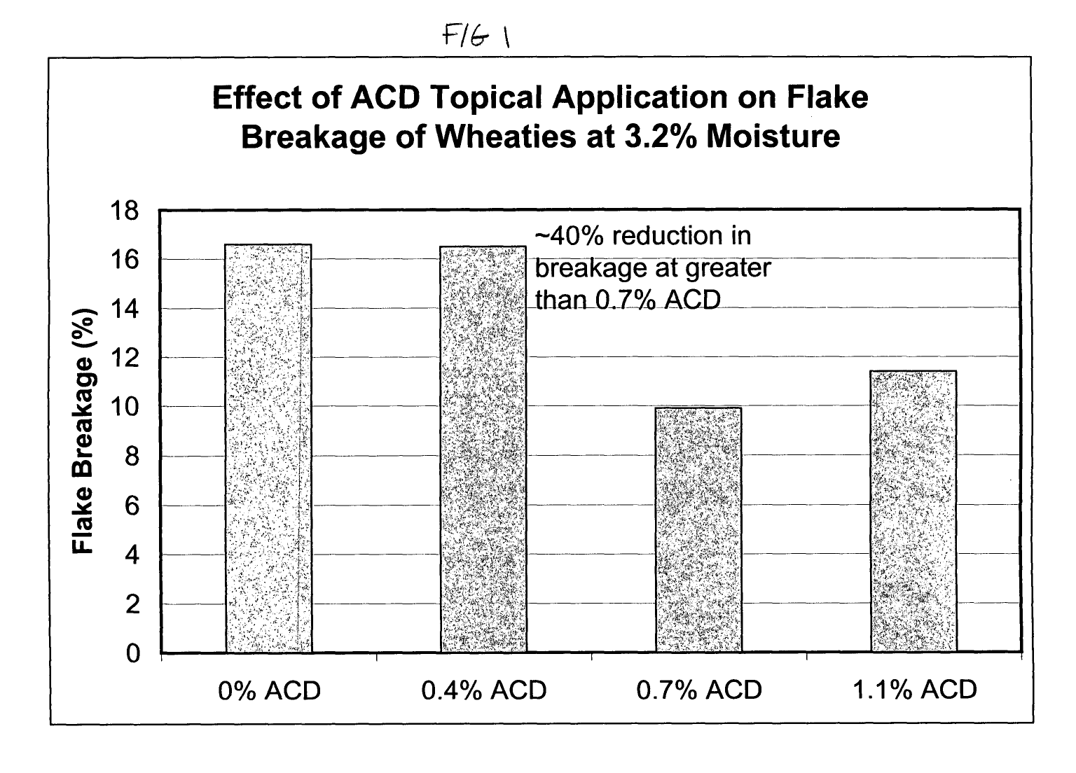

Four samples were evaluated, with various amounts of alpha cyclodextrin (“ACD”) applied to the flakes. The results of this evaluation are presented in FIG. 1. This experiment shows that breakage of the flakes is significantly reduced with a surprisingly small amount of ACD/oil topically applied to the flakes. Preferably, flakes exhibit a breakage rate that is at least about 20% lower, and more preferably at least about 40% lower than a like product that does not comprise cyclodextrin.

Bowl Life

R-T-E cereals are typically served in a bowl, with milk poured into the bowl. Generally, it is desired to avoid having the cereal become soggy and limp in the milk before the cereal is consumed. The resistance to becoming soggy over time may be evaluated by any technique appropriate for such evaluation. Preferably, this evaluation may be carried out by determining the force needed to crush ten grams of cereal in a Kramer Shear Cell. Cereal is tested dry and after soaking in milk for periods of 1, 3 and 5 minutes in milk.

Specifically, 10 grams of cereal is placed in a Kramer shear cell. The force needed to push 10 blades through the cereal is measured with a TA.HD Texture Analyzer. The test is repeated after soaking separate samples of cereal in milk for periods of 1, 3 and 5 minutes in 4° C. milk. Each point is tested in duplicate and the average is reported. If duplicate measurements are greater than 10 units apart, a third test is performed and the average of three is reported.

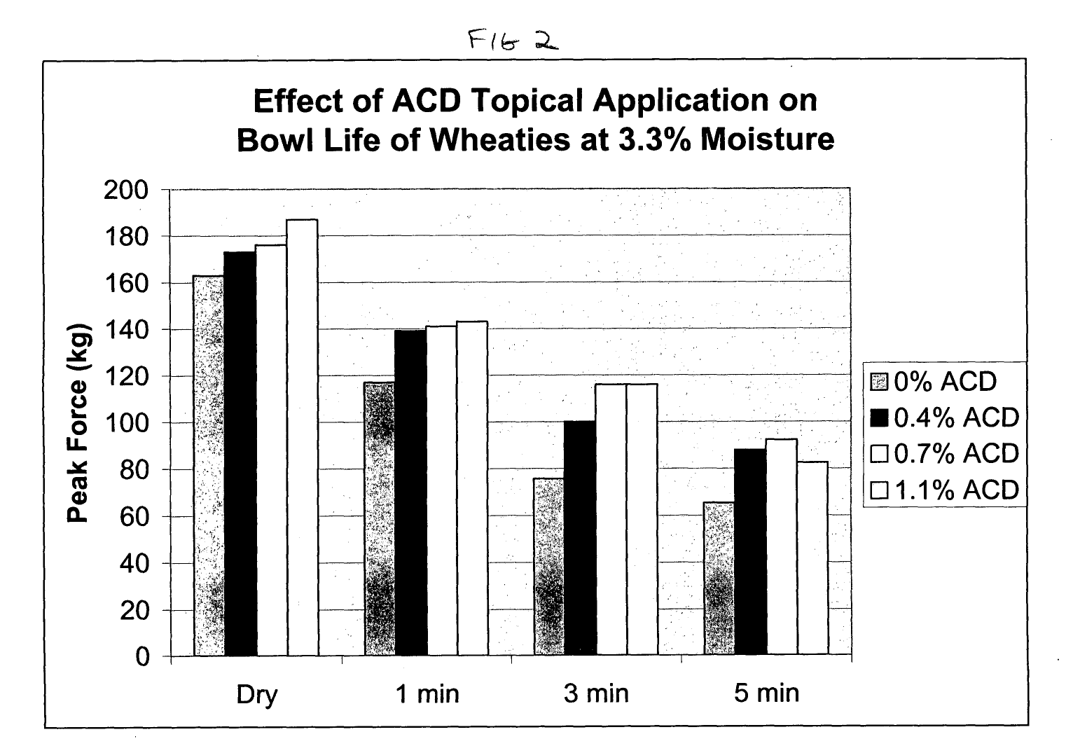

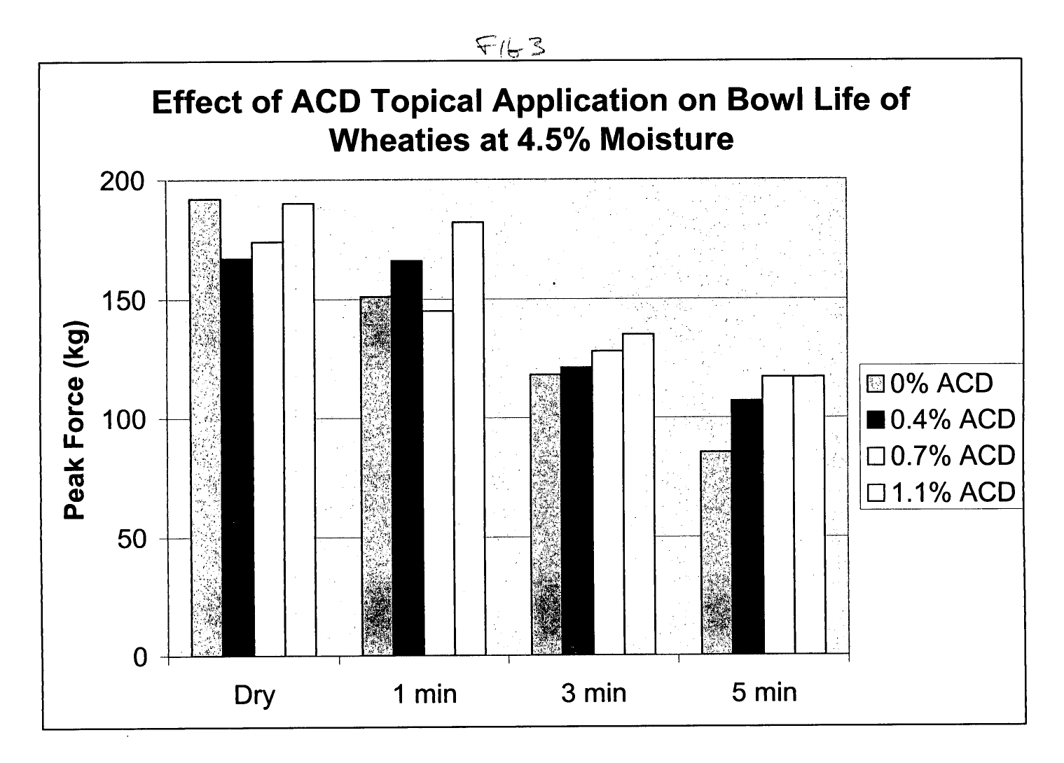

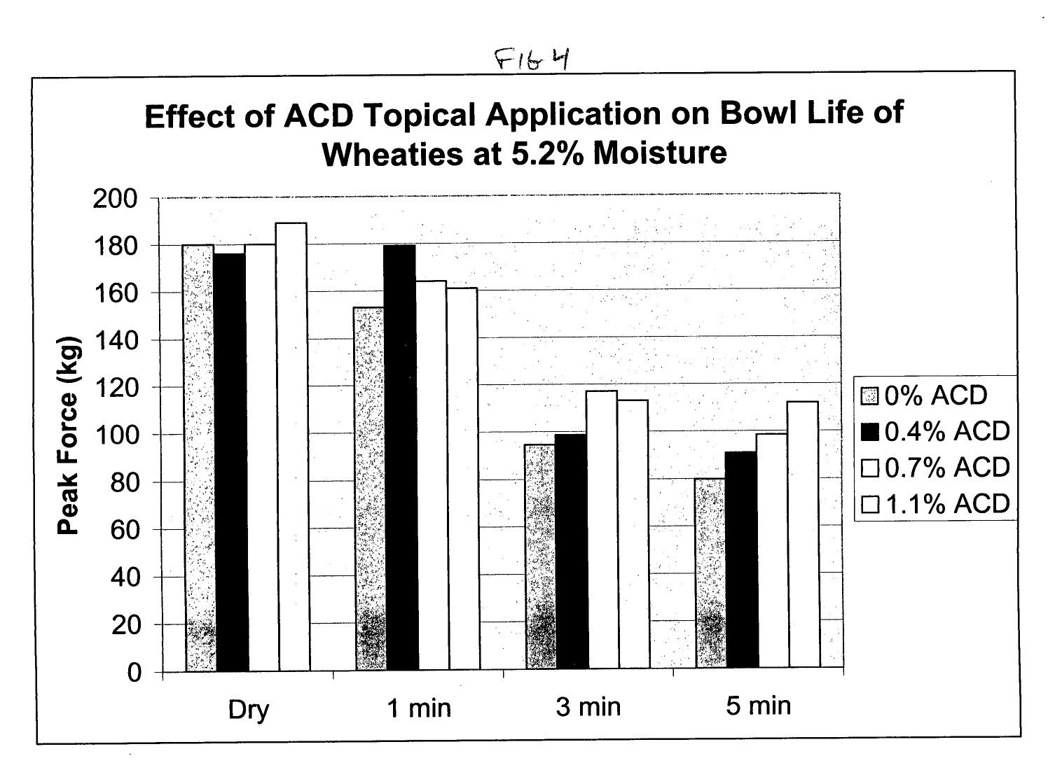

The results of this analysis at various flake moisture contents and ADC topical application weights are presented at FIGS. 2-4. It can be observed that excellent bowl life extension is achieved with the use of surprisingly low application weights of ADC/oil compositions, particularly at the critical time periods of 3-5 minutes after pouring of the milk. Preferably, the flakes of the present invention exhibit a bowl life force at 5 minutes that is the same or greater than the force exhibited by a like product that does not comprise cyclodextrin at 3 minutes.

Flavor Evaluation

Flavor of products are evaluated by sensory studies, where a trained person or panel is used to compare the apparent flavor of product by using side-by-side comparisons. The results of such studies are highly reproducible and provide excellent data regarding complex flavor component systems that would be difficult to analyze by direct chemical analysis systems.

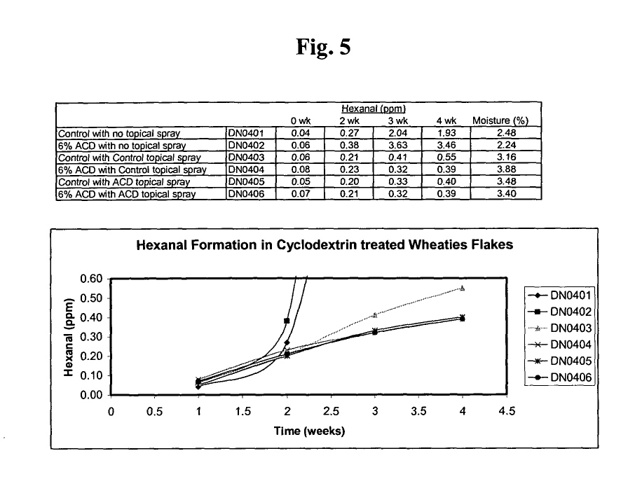

Additional analysis was carried out by evaluating the amount of hexanal emitted from samples over time. Hexanal emission is an indication that certain oils in the system are turning rancid, an indication of poor flavor stability of the product. An example of a hexanal analysis is shown in FIG. 5, wherein it can be seen that samples with ACD topical spray exhibit substantially lower hexanal emission as compared to other samples.

Flavor analysis was carried out using the following protocol:

Sensory Score

Method Overview

1. Obtain a sample of at least 500 grams of each of the grain-based components of the cereal to be evaluated. All fruit and nut particulates should be removed from the product.

2. Measure the initial moisture on the sample, and ensure the sample meets all quality specifications.

3. Fill eight 240-ml glass jars with the cereal to be tested. Ensure the glass jar lid is tightly sealed on each of the jars.

4. Store four of the jars in a 131° F.-temperature cabinet. The other four of the jars should be stored in a freezer to serve as sensory standards for the test.

5. At two, three, and four weeks, pull a sample from the 131° F. cabinet and from the freezer. Allow the samples to come to room temperature. Compare the 131° F. and freezer samples for odor and flavor using an appropriate “degree of difference” sensory scale. Be sure to record any comments regarding the reasoning behind the sensory scores. Also be sure assign an overall sensory score to the sample, and clearly concluded at the end of each sensory session whether or not the sample is still of acceptable sensory quality.

Degree of Difference Sensory Scale

1=Identical to 0° F. sample

2=Like fresh, but can be distinguished from the 0° F. when side by side

3=Clearly different from 0° F. sample, but has no objectionable characteristics

4=Contains some off-notes and/or has a soggier texture

5=Clearly Unacceptable

6. After the sensory analysis is completed, a hexanal analysis is run on the sample.

7. Continue the weekly evaluation for five weeks. The sixth jar serves as an extra in case a sample is broken, or question arises such that an extra pull is required.

8. When the test is completed, trend the sensory and hexanal data on a graph as a function of storage time. Note whether the quality of the sample changes gradually, than rapidly as the test proceeds, as shown in the plots below. This is a typical trend for rancidity development in cereal. A different shape trend may indicate a different

[image]

mechanism influencing the analysis, such as initial quality issues and non-rancidity related degradation reactions.

9. The above procedure was developed to estimate the relative rate a cereal sample will go rancid. This protocol will general provide direction as to the flavor stability of a formula. Artifacts will occur however, if the activation energy for a pertinent degradation reaction is significantly higher than that of oxidative rancidity.

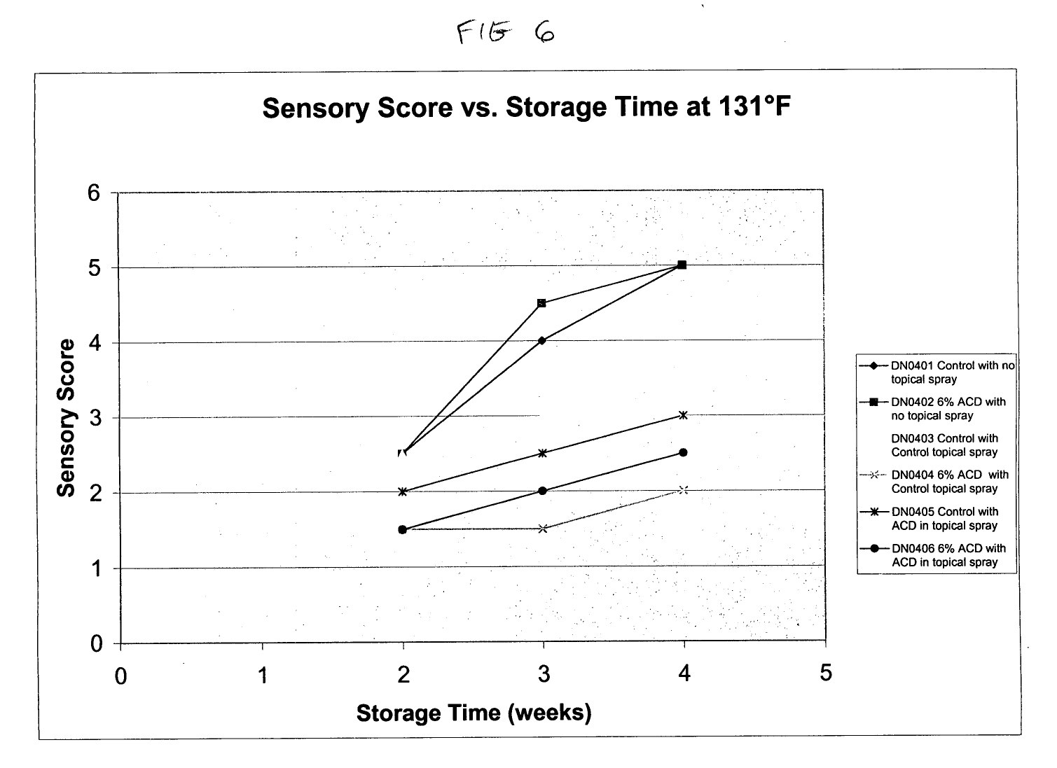

The sensory score as determined by a trained sensory expert is presented at FIG. 6, where it can be seen that flavor is surprisingly retained for longer periods of time. A sensory score of 3 or above is considered to be the point at which flavor no longer meets product expectations. Preferably, acceptable flavor is retained for a period that is at least about 30% longer, and more preferably at least about 40% longer than a like composition that does not comprise cyclodextrin.

All patents, patent documents, and publications cited herein are incorporated by reference as if individually incorporated. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

1. A method of improving flavor stability in a food product, comprising
incorporating at least one cyclodextrin in the food product in an amount effective to improve flavor stability.

2. The method of claim 1, wherein the cyclodextrin comprises alpha cyclodextrin.

3. The method of claim 1, wherein the cyclodextrin is applied topically to the food product.

4. The method of claim 3, wherein the cyclodextrin is applied to the food product after the final heat treatment of the food product.

5. The method of claim 1, wherein the cyclodextrin is internally incorporated in the food product.

6. A method of improving textural stability of a food product, comprising
incorporating at least one cyclodextrin in the food product in an amount effective to improve textural stability.

7. The method of claim 6, wherein the cyclodextrin comprises alpha cyclodextrin.

8. The method of claim 6, wherein the cyclodextrin is applied topically to the food product.

9. The method of claim 8, wherein the cyclodextrin is applied to the food product after the final heat treatment of the food product

10. The method of claim 6, wherein the cyclodextrin is internally incorporated in the food product.

11. The method of claim 6, wherein the food product comprises a plurality of components, wherein the water content difference between two of the components is at least 1%.

12. A method of forming a food treatment composition, comprising:
a) providing a cyclodextrin;
b) hydrating the cyclodextrin with water; and
c) mixing the hydrated cyclodextrin with a fat to form a cyclodextrin/fat composition.

13. A food treatment composition comprising a hydrated cyclodextrin intimately mixed with a fat.

14. The food treatment composition of claim 13, wherein the fat is selected from the group consisting of soybean oil, corn oil, canola oil, olive oil, sunflower oil, peanut oil, palm oil, palm kernel oil and coconut oil.

15. A method of treating a food composition, comprising:
a) providing the cyclodextrin/fat composition of claim 13;
b) incorporating the cyclodextrin/fat composition in the food composition.

16. A method of treating a food product, comprising:
a) providing the cyclodextrin/fat composition of claim 13;
b) topically applying the cyclodextrin/fat composition to the food product.

17. A food product having the cyclodextrin/fat composition of claim 13 incorporated therein.

18. A food product having the cyclodextrin/fat composition of claim 13 topically applied thereto.

19. A method of making a food product, comprising
a) determining information indicative of the impact that an amount of cyclodextrin has upon a textural stability characteristic of a food product,
b) using the information determined in step b) to formulate a food product recipe comprising cyclodextrin.

20. A method of making a food product, comprising
a) determining information indicative of the impact that an amount of cyclodextrin has upon a flavor stability characteristic of a food product,
b) using the information determined in step b) to formulate a food product recipe comprising cyclodextrin.
